(19) United States
(12) Patent Application Publication
(10) Pub. No.: US 2019/0253799 A1
(43) Pub. Date: Aug. 15, 2019

(54) Electronic device

(71) Applicant: AAC Technologies Pte. Ltd., Singapore City (SG)

(72) Inventors: Yulei Zhang, Shenzhen (CN); Xiuyue Wang, Shenzhen (CN); Jianqi Li, Shenzhen (CN); Bing Xie, Shenzhen (CN)

(21) Appl. No.: 16/236,393

(22) Filed: Dec. 29, 2018

(30) Foreign Application Priority Data
Feb. 11, 2018 (CN) 201810143392.5

(51) Int. Cl. H04R 5/02; H04R 1/02; H04R 1/30

(52) U.S. Cl. CPC H04R 5/02; H04R 1/30; H04R 1/025

(57) ABSTRACT

The present disclosure relates to the field of communication technology, and in particular, to an electronic device. The electronic device includes a main body having at least two acoustic cavities isolated from each other, the acoustic cavities including a first acoustic cavity and a second acoustic cavity; a processor configured to generate a plurality of control signals independent from each other, the plurality of control signals including a first control signal and a second control signal; a speaker electrically connected to the processor and configured to output a sound signal in accordance with the first control signal; and a vibrator electrically connected to the processor and capable of vibrating with respect to the main body in accordance with the second control signal. One of the speaker and the vibrator is provided in the first acoustic cavity and the other is provided in the second acoustic cavity.

### CROSS-REFERENCE TO RELATED APPLICATIONS

The present application claims priority to Chinese Patent Application No. 201810143392.5, filed on Feb. 11, 2018, the content of which is incorporated herein by reference in its entirety.

### TECHNICAL FIELD

The present disclosure relates to the field of communication technology, and in particular, to an electronic device.

### BACKGROUND

With the continuous development of communication technologies, people's demands on functions of electronic devices, including experiences of audio effect playing, become increasingly higher. It is known that audio playing and vibration playing are two important techniques for electronic devices. Accordingly, their playing effects will direct affect the playing experiences of electronic devices.

In an existing playing technique, audios and vibrations cannot be played simultaneously due to limitations in horn settings and play control methods. In another existing playing technique, while separate signals can be used to drive an audio player and a motor to achieve a vibration effect while playing an audio, these signals need to be controlled accurately and it is thus difficult to ensure the audio and the vibration to be played synchronously, resulting in a bad user experience.

### BRIEF DESCRIPTION OF DRAWINGS

FIG. 1 is a block diagram showing a structure of an electronic device according to an embodiment of the present disclosure.

### REFERENCE SIGNS

10 Processor

20 Speaker

30 Vibrator

40 First Power Amplifier

50 Second Power Amplifier

The FIGURE is incorporated in the description and constitutes a part of the description. The FIGURE shows an embodiment of the present disclosure and explains the principle of the present disclosure along with the description.

### DESCRIPTION OF EMBODIMENTS

In the following, the present disclosure will be described in further detail with reference to the specific embodiment taken in conjunction with the FIGURE.

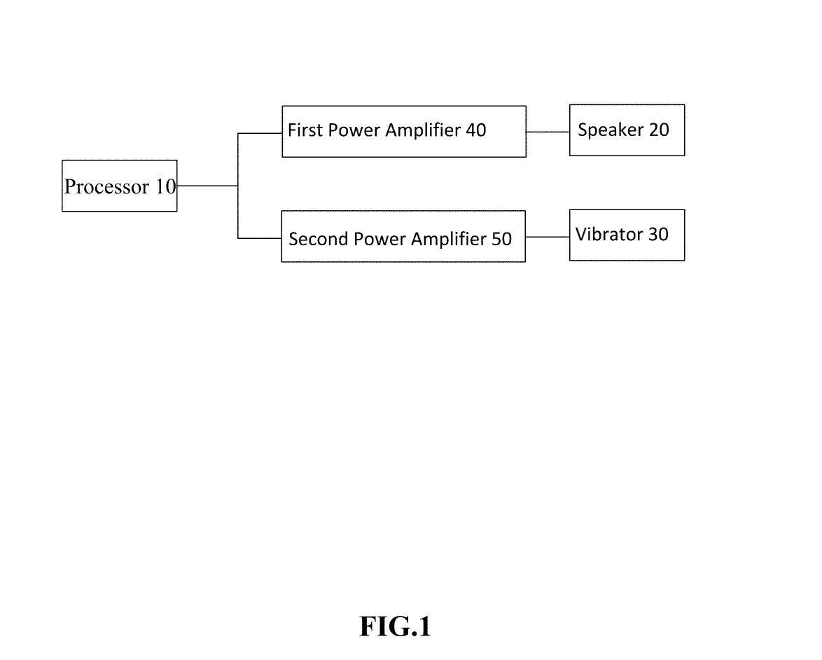

As shown in FIG. 1, an electronic device is provided according to an embodiment of the present disclosure. The electronic device can be a mobile phone or a tablet computer. The electronic device has functions of playing sound effects such as audios and vibrations. In particular, the electronic device can include a playing component.

More specifically, the playing component can include a main body, which can be a basis on which other elements of the playing component are provided (e.g., installed). The main body has at least two acoustic cavities isolated from each other (i.e., not communicated with each other) such that they will not interfere with each other while playing. The acoustic cavities include a first acoustic cavity and a second acoustic cavity;

The playing component can further include a processor 10 configured to generate a plurality of control signals independent from each other, such that the processor 10 can control operations of relevant elements. Each of the plurality of control signals includes a first control signal and a second control signal.

The playing component can further include a speaker 20 electrically connected to the processor 10. The speaker 20 can receive the first control signal transmitted from the processor 10 and output a sound signal in accordance with the first control signal. That is, the speaker 20 may produce audios. In an optional embodiment, the speaker 20 can be a horn, so as to ensure the playing effect of the speaker 20 while simplifying the structure of the electronic device.

The playing component can further include a vibrator 30 electrically connected to the processor 10. The vibrator 30 can receive the second control signal transmitted from the processor 10 and can vibrate with respect to the main body in accordance with the second control signal. The vibrator 30 can play a vibration effect. In an optional embodiment, the vibrator 30 can be a motor, so as to ensure the playing effect of the vibrator 30 while simplifying the structure of the electronic device.

One of the speaker 20 and the vibrator 30 is provided in the above-described first acoustic cavity and the other is provided in the above-described second acoustic cavity. The speaker 20 and the vibrator 30 can be in a playing state simultaneously.

In particular, the processor 10 can be electrically connected to the speaker 20 and the vibrator 30 simultaneously. It can transmit the first control signal and the second control signal to the speaker 20 and the vibrator 30, respectively, using an I2C transmission protocol. Here, according to the I2C transmission protocol, the control signals can be transmitted via an I2C bus, which is a simple bidirectional dual-line synchronous serial bus and only needs two lines to transmit information between devices connected to the bus.

In the electronic device according to an embodiment of the present disclosure, the speaker 20 and the vibrator 30 are provided within different acoustic cavities in the main body. One single processor 10 can control both the speaker 20 and the vibrator 30, such that the vibrator 30 may vibrate while the speaker 20 is playing an audio, thereby playing the audio and vibration simultaneously. Further, with the electronic device controlling the speaker 20 and the vibrator 30 simultaneously using one single processor 10, it is possible to ensure the synchronization between the speaker 20 and the vibrator 30. In this way, the effect of simultaneously playing the audio and vibration can be enhanced, such that the user experience can be improved.

In a conventional electronic device, the speaker 20 is provided in each acoustic cavity. In the above solution, the speaker 20 in at least one of the acoustic cavities of the conventional electronic device can be replaced with the vibrator, such that the processor 10 can directly control the vibrator 30 to vibrate. Hence, the electronic device according to the embodiment of the present disclosure can enhance the effect of simultaneously playing the audio and vibration and is easy to implement, thereby reducing the development cost of the electronic device.

The playing scheme of the electronic device may be a dual-channel playing scheme or a multi-channel playing scheme. The present disclosure provides the following embodiments for these two schemes.

### First Embodiment

Two acoustic cavities, i.e., the above-described first acoustic cavity and second acoustic cavity, are provided in the main body. The first acoustic cavity corresponds to a left channel and the second acoustic cavity corresponds to a right channel. That is, a dual-channel playing scheme is used. In this case, the speaker 20 can be provided in the first acoustic cavity and the vibrator 30 can be provided in the second acoustic cavity. Alternatively, the speaker 20 can be provided in the second acoustic cavity and the vibrator 30 can be provided in the first acoustic cavity. This dual-channel playing scheme can satisfy playing requirements of most electronic devices while making the structure of the electronic device simple.

### Second Embodiment

There are a plurality of first acoustic cavities, a plurality of second acoustic cavities, or both. Each of the first acoustic cavities and each of the second acoustic cavities correspond to different channels. That is, a multi-channel playing scheme is used. In this embodiment, the number of first acoustic cavities and the number of second acoustic cavities can be determined depending on actual situations. The total number of first acoustic cavities and second acoustic cavities can be even or odd. When the total number of first acoustic cavities and second acoustic cavities is even, the number of speakers 20 can be equal to, larger than or smaller than the number of vibrators 30. When the total number of first acoustic cavities and second acoustic cavities is odd, the number of speakers 20 can be larger than the number of vibrators 30, or the number of vibrators 30 can be larger than the number of speakers 20.

In an optional embodiment, there can be the plurality of first acoustic cavities each having the speaker 20 provided therein. There can be one second acoustic cavity having the vibrator 30 provided therein. That is, one vibrator 30 can be provided in the entire playing component and can satisfy the vibration requirements of the electronic device. Moreover, when there is a plurality of speakers 20, the audio can be played via at least two channels, thereby improving the audio playing effect of the electronic device.

In order to guarantee the playing effect of the playing component, as shown in FIG. 1, the playing component can further include a first power amplifier 40 configured to amplify power of the above-described first control signal. The processor 10 is electrically connected to the speaker 20 via the first power amplifier 40. That is, the first control signal generated by the processor 10 is amplified by the first power amplifier 40 before being transmitted to the speaker 20, such that the speaker 20 can have a better playing effect. Here, the first control signal may include audio data.

The playing component can further include a second power amplifier 50 configured to amplify power of the above-described second control signal. The processor 10 is electrically connected to the vibrator 30 via the second power amplifier 50. That is, the second control signal generated by the processor 10 is amplified by the second power amplifier 50 before being transmitted to the vibrator 30, such that the vibrator 30 can have a better vibration effect. Here, the second control signal may include a vibration waveform.

The above first power amplifier 40 and second power amplifier 50 can synchronize the first control signal and the second control signal, such that the speaker 20 and the vibrator 30 can be in a playing state simultaneously, thereby preventing them from playing asynchronously.

A volume of the speaker 20 and a vibration intensity of the vibrator 30 are important operation parameters of them. Usually, in a quite environment, the volume of the speaker 20 and the vibration intensity of the vibrator 30 can be set to small values so as not to be disturbing. In a chaotic environment, the volume of the speaker 20 and the vibration intensity of the vibrator 30 can be set to large values, such that a user can hear the sounds from the speaker 20 and the vibrator 30 clearly. In light of this, the playing component according to an embodiment of the present disclosure can further include an adjuster provided in the main body, electrically connected to both the speaker 20 and the vibrator 30, and configured to adjust operation parameters of the speaker 20 and the vibrator 30. The operation parameters may include the volume of the speaker 20 and the vibration intensity of the vibrator 30. With this structure, the adjuster can adjust the operation parameters of the speaker 20 and the vibrator 30 synchronously, so as to guarantee their adjustment effects.

In particular, the above adjuster can be an adjustment switch. For details of the structure of the adjustment switch, reference can be made to the related art and these details will be omitted here.

While the embodiments of the present disclosure have been described above, the present disclosure is not limited thereto. Various modifications and alternatives can be made by those skilled in the art. All these modifications, alternatives and improvements that are made without departing from the spirits and principles of the present disclosure are to be encompassed by the scope of the present disclosure.

What is claimed is:

1. An electronic device, comprising a playing component which comprises:
a main body having at least two acoustic cavities isolated from each other, the at least two acoustic cavities comprising a first acoustic cavity and a second acoustic cavity;
a processor configured to generate a plurality of control signals independent from each other, each of the plurality of control signals comprising a first control signal and a second control signal;
a speaker electrically connected to the processor and configured to output a sound signal in accordance with the first control signal; and
a vibrator electrically connected to the processor and capable of vibrating with respect to the main body in accordance with the second control signal,
wherein one of the speaker and the vibrator is provided in the first acoustic cavity and the other one of the speaker and the vibrator is provided in the second acoustic cavity, and wherein the speaker and the vibrator can be in a playing state simultaneously.

2. The electronic device as described in claim 1, wherein the main body has two acoustic cavities: the first acoustic cavity corresponding to a left channel and the second acoustic cavity corresponding to a right channel.

3. The electronic device as described in claim 1, wherein the main body has a plurality of first acoustic cavities, a plurality of second acoustic cavities, or both, and wherein each of the plurality of first acoustic cavities and each of the plurality of second acoustic cavities correspond to different channels.

4. The electronic device as described in claim 3, wherein the main body has the plurality of first acoustic cavities each having the speaker provided therein, and
the main body has one second acoustic cavity having the vibrator provided therein.

5. The electronic device as described in claim 1, wherein the playing component further comprises:
a first power amplifier configured to amplify power of the first control signal, wherein the processor is electrically connected to the speaker via the first power amplifier; and
a second power amplifier configured to amplify power of the second control signal, wherein the processor is electrically connected to the vibrator via the second power amplifier,
wherein the first power amplifier and the second power amplifier synchronize the first control signal and the second control signal.

6. The electronic device as described in claim 1, wherein the playing component further comprises an adjuster provided in the main body, the adjuster being electrically connected to both the speaker and the vibrator, and configured to adjust operation parameters of the speaker and the vibrator.

7. The electronic device as described in claim 1, wherein the speaker comprises a horn and the vibrator comprises a motor.
